(19) United States
(12) Patent Application Publication
(10) Pub. No.: US 2022/0300883 A1
(43) Pub. Date: Sep. 22, 2022

(54) QUALITY ESTIMATION DEVICE AND METHOD

(71) Applicant: Panasonic Intellectual Property Management Co., Ltd., Osaka (JP)

(72) Inventors: Daijiroh ICHIMURA, Hyogo (JP); Yoshiyuki OKIMOTO, Nara (JP); Hidehiko SHIN, Osaka (JP); Akira MINEGISHI, Osaka (JP); Yosuke TAJIKA, Hyogo (JP)

(21) Appl. No.: 17/838,227

(22) Filed: Jun. 12, 2022

Related U.S. Application Data
(63) Continuation of application No. PCT/JP2020/025488, filed on Jun. 29, 2020.

(30) Foreign Application Priority Data
Dec. 27, 2019 (JP) 2019-238683

(51) Int. Cl. G06Q 10/06

(52) U.S. Cl. CPC G06Q 10/06395

(57) ABSTRACT

A quality estimation device for generating information on quality with which a plurality of unit products are obtained by using a plurality of facilities to pass at least one step, includes: a memory that stores quality control data associating the facilities passed for each of the unit products in the step when the unit products are obtained, with quality for the obtained unit products; and a circuit that controls calculation processing based on the quality control data stored in the memory. The circuit extracts a plurality of pass records from the quality control data, the plurality of pass records each indicating a series of facilities passed by a unit product in the plurality of unit products and quality for the unit product, and generates facility quality information indicating quality with respect to a facility in the plurality of facilities by the calculation processing, based on the extracted pass records.

### BACKGROUND

### 1. Technical Field

The present disclosure relates to a quality estimation device and method.

### 2. Related Art

JP 2006-319220 A discloses is an abnormal facility estimation device for estimating a manufacturing facility that causes a deterioration in product quality in a manufacturing system that manufactures a product using any of a plurality of manufacturing facilities for each of a plurality of process steps. The abnormal facility estimation device generates analysis data in which a quality inspection result and the identification information of manufacturing facility are associated with each other for each product identification information. The abnormal facility estimation device classifies the analysis data using a decision tree analysis method and calculates the degrees of influence of classifications according to the lower nodes of the generated decision tree on the classifications according to the corresponding upper nodes. In this way, by calculating the degree of influence of the manufacturing facility assigned to each node on the quality deterioration, the manufacturing facility that causes the quality deterioration of the product is estimated.

### SUMMARY

The present disclosure provides a quality estimation device and method that can accurately estimate quality per a facility regarding the quality when a plurality of unit products are obtained by using a plurality of facilities.

A quality estimation device according to one aspect of the present disclosure generates information on the quality with which a plurality of unit products are obtained by using a plurality of facilities to pass at least one step. The quality estimation device includes a memory and a circuit. The memory stores quality control data associating the facility passed for each of the unit products in the step when the unit products are obtained, with the quality for the obtained unit products. The circuit controls calculation processing based on the quality control data stored in the memory. The circuit extracts, from the quality control data, a plurality of pass records each indicating a series of facilities passed by a unit product in the plurality of unit products and the quality for the unit product. The circuit generates facility quality information indicating the quality with respect to a facility in the plurality of facilities by the calculation processing based on the extracted pass records.

These general and specific aspects may be implemented by systems, methods, and computer programs, and combinations of them.

The quality estimation device and method according to the present disclosure can accurately estimate quality per a facility regarding the quality when a plurality of unit products are obtained by using a plurality of facilities.

### BRIEF DESCRIPTION OF THE DRAWINGS

FIG. 1 is a diagram for explaining an outline of a quality estimation device according to the first embodiment of the present disclosure;

FIG. 2 is a block diagram illustrating the configuration of the quality estimation device;

FIG. 3 is a functional block diagram showing the functional configuration in the quality estimation device;

FIG. 4 is a view illustrating the data structure of quality control data in the quality estimation device;

FIG. 5 is a flowchart illustrating the operation of the quality estimation device according to the first embodiment;

FIG. 6 is a view showing a display example of a low yield lot detector in the quality estimation device;

FIG. 7 is a view showing a display example of a bottleneck facility determiner in the quality estimation device;

FIG. 8 is a view showing a display example of a time series analyzer in the quality estimation device;

FIG. 9 is a view for explaining the formulation of a facility yield estimation method;

FIG. 10 is a flowchart illustrating facility yield analysis processing in the quality estimation device according to the first embodiment;

FIG. 11 is a flowchart illustrating time series analysis processing in the quality estimation device according to the first embodiment;

FIGS. 12A and 12B are views for explaining the numerical simulation of the facility yield estimation method; and

FIG. 13 is a flowchart illustrating facility yield analysis processing in the quality estimation device according to the second embodiment.

### DESCRIPTION OF EMBODIMENTS

Embodiments will be described in detail below with reference to the accompanying drawings as appropriate. However, detailed descriptions more than necessary may be omitted. For example, detailed description of an already well-known matter and a duplicate description of substantially the same configuration may be omitted. This is to avoid unnecessary redundancy of the following description and to facilitate the understanding of those skilled in the art.

It should be noted that the applicant provides the accompanying drawings and the following description in order to allow those skilled in the art to fully understand the present disclosure and does not intend to make them limit the subject matter described in the claims.

### First Embodiment

The first embodiment of the present disclosure will be described below with reference to the accompanying drawings.

### 1. Configuration

### 1-1. Overview

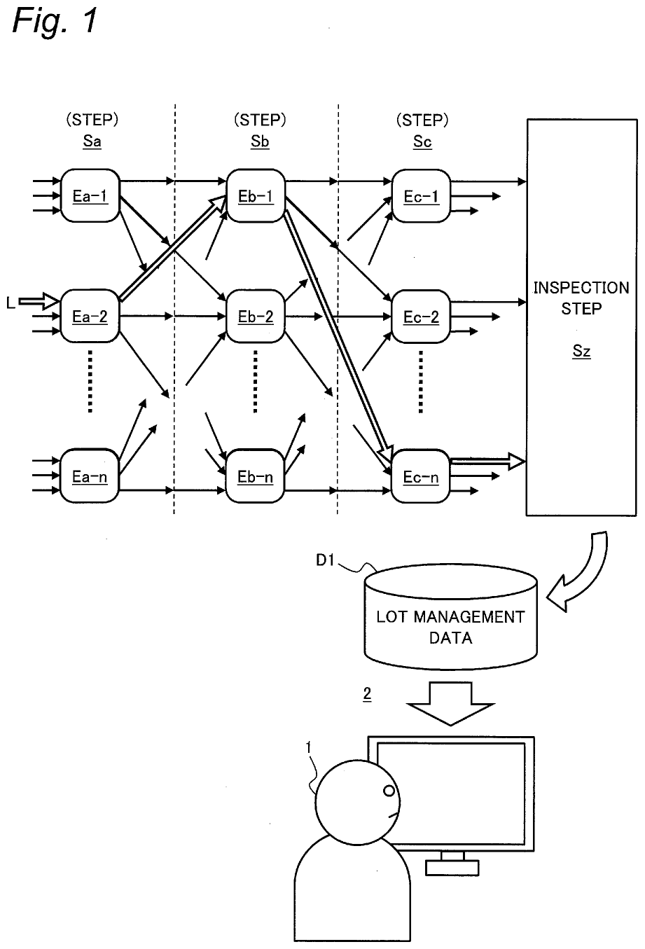

FIG. 1 is a diagram for explaining an outline of a quality estimation device 2 according to the present embodiment. The quality estimation device 2 according to the present embodiment is applied to data analysis for a user 1 such as a manager to control quality in a factory facility that produces products such as electronic parts in lot units such as tens of thousands. For example, the factory facility includes a plurality of facilities Ea-1 to Ec-n for producing a plurality of lots in parallel. The products in lots are an example of unit products in the present embodiment.

FIG. 1 illustrates a case in which there are a series of steps Sa to Sc for producing products in each lot, followed by final inspection step Sz. In this case, the plurality of facilities Ea-1 to Ec-n are classified into three steps Sa, Sb, Sc. The facilities Ea-1 to Ea-n, Eb-1 to Eb-n, and Ec-1 to Ec-n for the respective steps Sa, Sb, and Sc are provided in one or more factories to perform the same processing in each of steps Sa, Sb, and Sc, for example. The number of steps and the number of facilities are not particularly limited, and the number of facilities for each step may differ, for example. Hereinafter, the generic terms of the facilities Ea-1 to Ec-n may be referred to as “facilities E”.

For a plurality of lots, various combinations of facilities E are used for each of steps Sa, Sb, and Sc. For example, in a specific lot L in the example of FIG. 1, step Sa is processed by the facility Ea-2, step Sb is processed by the facility Eb-1, and step Sc is processed by the facility Ec-n. Subsequently, in final inspection step Sz, the final yield, which is the ratio of products in the specific lot L excluding defective products, is measured by various inspection items. Lot management data D1 including various information for managing each lot such as the final yield is sequentially collected and accumulated. The lot management data D1 is an example of quality control data in the present embodiment.

In the above factory facility, when a decrease in final yield is found in inspection step Sz, the manager or the like may demand for specifying the facility that has caused the decrease in quality in steps Sa to Sc on the way to inspection step Sz to take countermeasures. However, the prior art is configured to only calculate the degree of influence that facility has on the final defect rate as the influence from a lower node to an upper node by using e.g. a decision tree analysis method (see JP 2006-319220 A). Thus, the prior art has a difficulty in directly estimating the yield of each facility E.

In contrast to this, the present embodiment provides the quality estimation device 2 that can directly estimate facility yield that is the yield per the facility E, based on the lot management data D1. This makes it possible to estimate the quality of each facility E with high accuracy. This allows the user 1 to take effective measures, such as performing maintenance upon prioritizing among the facilities Ea-1 to Ec-n, according to the facility yield of each facility E obtained from the quality estimation device 2.

### 1-2. Configuration of Quality Estimation Device

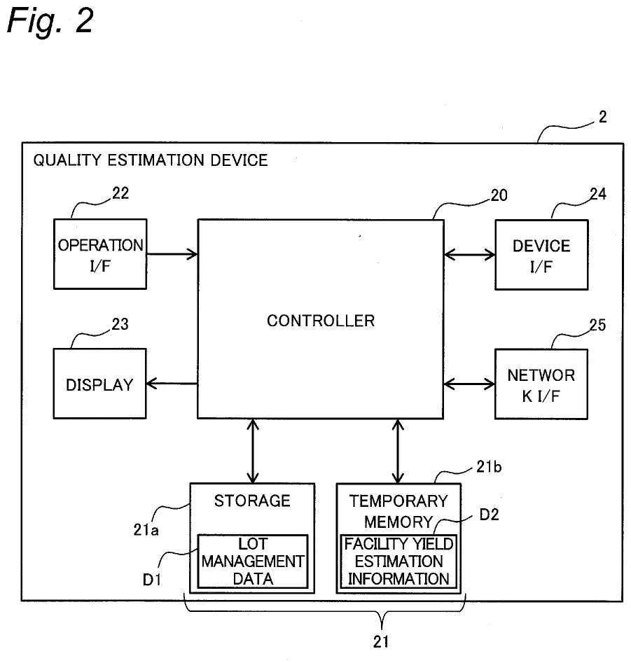

The configuration of the quality estimation device 2 according to the present embodiment will be described with reference to FIGS. 2 to 4. FIG. 2 is a block diagram illustrating the configuration of the quality estimation device 2.

The quality estimation device 2 is configured by an information processing device such as a PC. The quality estimation device 2 illustrated in FIG. 2 includes a controller 20, a memory 21, an operation interface 22, a display 23, a device interface 24, and a network interface 25. The interface may be abbreviated as “I/F” below.

For example, the controller 20 as an example of a circuit includes a CPU or MPU that implements a predetermined function in cooperation with software and controls the overall operation of the quality estimation device 2. The controller 20 reads data and programs stored in the memory 21 and performs a variety of calculation processing to implement various functions.

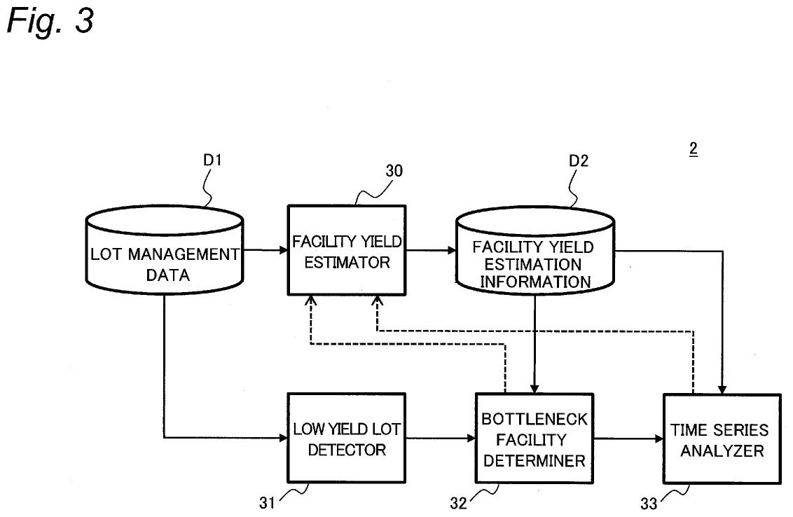

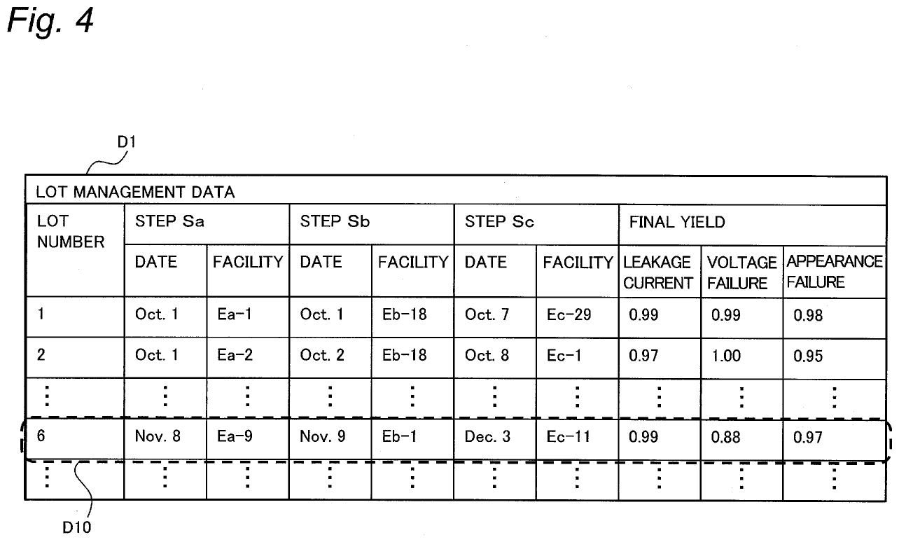

FIG. 3 is a functional block diagram showing the functional configuration in the quality estimation device 2. For example, the quality estimation device 2 includes, as a functional configuration of the controller 20, a facility yield estimator 30 that generates facility yield estimation information D2 based on the lot management data D1, a low yield lot detector 31, a bottleneck facility determiner 32, and a time series analyzer 33. FIG. 4 illustrates the data structure of the lot management data D1.

In an example shown in FIG. 4, the lot management data D1 has a “lot number” for identifying a lot, a “date” and “facility” for each of steps Sa, Sb, and Sc, and various inspection items of the final yield, which are associated with each other, and manages them as lot route information D10. In this example, the inspection items of the final yield include “voltage failure”, “appearance failure”, and “leakage current”. The items of the final yield is not particularly limited to the above and may include other inspection items. In addition to the measured value for each inspection item, the lot management data D1 may be configured to manage the total value of the final yield in consideration of each inspection item.

The lot route information D10 indicates the route of the lot identified by a lot number, which is constituted by a series of facilities, by indicating the “facility” in each of steps Sa, Sb, and Sc which the lot passes at the “date”. For example, the route of the lot with lot number “6” passes the facility Ea-9 in step Sa on “November 8”, passes the facility Eb-1 in step Sb on “November 9”, and passes the facility Ec-11 in step Sc on “December 3”.

The facility yield estimator 30 in FIG. 3 calculates facility yield estimation information D2 by performing calculation processing described later using the plurality of pieces of lot route information D10 in the lot management data D1. The facility yield estimation information D2 is an example of facility quality information in the present embodiment.

The low yield lot detector 31 detects a low yield lot, which is a lot having a significantly low final yield, based on the lot management data D1. For example, the bottleneck facility determiner 32 determines bottleneck facility that is presumed to be the cause of quality deterioration from the facilities E which the low yield lot has passed. For example, the time series analyzer 33 generates information indicating the temporal change in the facility yield of bottleneck facility. The functions of the bottleneck facility determiner 32 and the time series analyzer 33 are implemented by using the facility yield estimation information D2 corresponding to each condition (to be described in detail later).

Returning to FIG. 2, the controller 20 executes a program including a group of instructions for implementing the function of the quality estimation device 2 or the quality estimation method as described above, for example. The above program may be provided from a communication network such as Internet or may be stored in a portable recording medium. Further, the controller 20 may be a hardware circuit such as a dedicated electronic circuit or a reconfigurable electronic circuit designed to implement each of the above functions. The controller 20 may be composed of various semiconductor integrated circuits such as CPU, MPU, GPU, GPGPU, TPU, microcomputer, DSP, FPGA, and ASIC.

The memory 21 is a storage medium that stores programs and data necessary for implementing the functions of the quality estimation device 2. As shown in FIG. 2, the memory 21 includes a storage 21a and a temporary memory 21b.

The storage 21a stores parameters, data, a control program, and the like for implementing a predetermined function. For example, the storage 21a includes an HDD or SSD. For example, the storage 21a stores the above program, the quality control data D1, and the like.

For example, the temporary memory 21b includes a RAM such as DRAM or SRAM and temporarily stores (i.e., holds) data. For example, the temporary memory 21b holds the facility yield estimation information D2 and the like. Further, the temporary memory 21b may function as a work area of the controller 20 or may be a storage area in the internal memory of the controller 20.

The operation interface 22 is a generic term for operation members operated by the user. The operation interface 22 may form a touch panel together with the display 23. The operation interface 22 is not limited to the touch panel and may be a keyboard, a touch pad, buttons, or switches, for example. The operation interface 22 is an example of an input interface that acquires various information input by the user's operation.

The display 23 is an example of an output interface configured by a liquid crystal display or organic EL display, for example. The display 23 may display various information such as various icons for operating the operation interface 22 and information input from the operation interface 22.

The device I/F 24 is a circuit for connecting an external device to the quality estimation device 2. The device I/F 24 is an example of a communication interface that performs communication according to a predetermined communication standard. Predetermined standards include USB, HDMI (registered trademark), IEEE1394, WiFi, and Bluetooth (registered trademark). The device I/F 24 may be an input interface for receiving various information or an output interface for transmitting various information from or to the external device in the quality estimation device 2.

The network I/F 25 is a circuit for connecting the quality estimation device 2 to the communication network via a wireless or wired communication line. The network I/F 25 is an example of a communication interface that performs communication complying with a predetermined communication standard. Predetermined communication standards include communication standards such as IEEE802.3 and IEEE802.11a/11b/11g/11ac. The network I/F 25 may be an input interface for receiving various information or an output interface for transmitting various information in the quality estimation device 2 via the communication network.

The configuration of the quality estimation device 2 as described above is an example, and the configuration of the quality estimation device 2 is not limited to this. The quality estimation device 2 may be composed of various computers including a server device. The quality estimation method according to the present embodiment may be executed in distributed computing. Further, the input interface in the quality estimation device 2 may be implemented in cooperation with various software in the controller 20 and the like. The input interface in the quality estimation device 2 acquires various information by reading various information stored in various storage media (e.g., the storage 21a) into the work area of the controller 20 (e.g., the temporary memory 21b).

### 2. Operation

The operation of the quality estimation device 2 configured as described above will be described below.

The quality estimation device 2 according to the present embodiment executes calculation processing for estimating the facility yield in the facility yield estimator 30, based on the lot management data D1 stored in advance in the memory 21, for example. The facility yield estimation method according to the present embodiment implements formulation by focusing on the situation where various lots pass through various facilities Ea-1 to Ec-n for each of steps Sa to Sc, thereby allowing direct estimation of the facility yield of each of the facilities Ea-1 to Ec-n. The facility yield estimation method according to the present embodiment will be described in detail later.

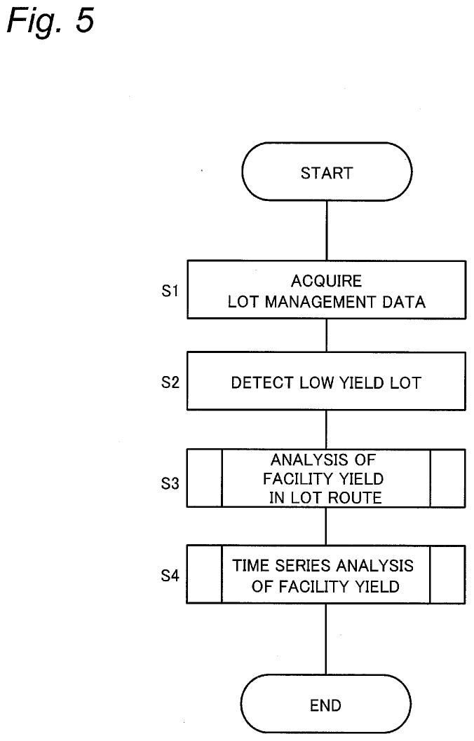

To utilize the facility yield estimation information D2 obtained from the above processing, the overall operation of the quality estimation device 2 according to the present embodiment will be described with reference to FIGS. 5 to 8. FIG. 5 is a flowchart exemplifying the operation of the quality estimation device 2 according to the present embodiment. The processing shown in this flowchart is executed by the controller 20 of the quality estimation device 2, for example.

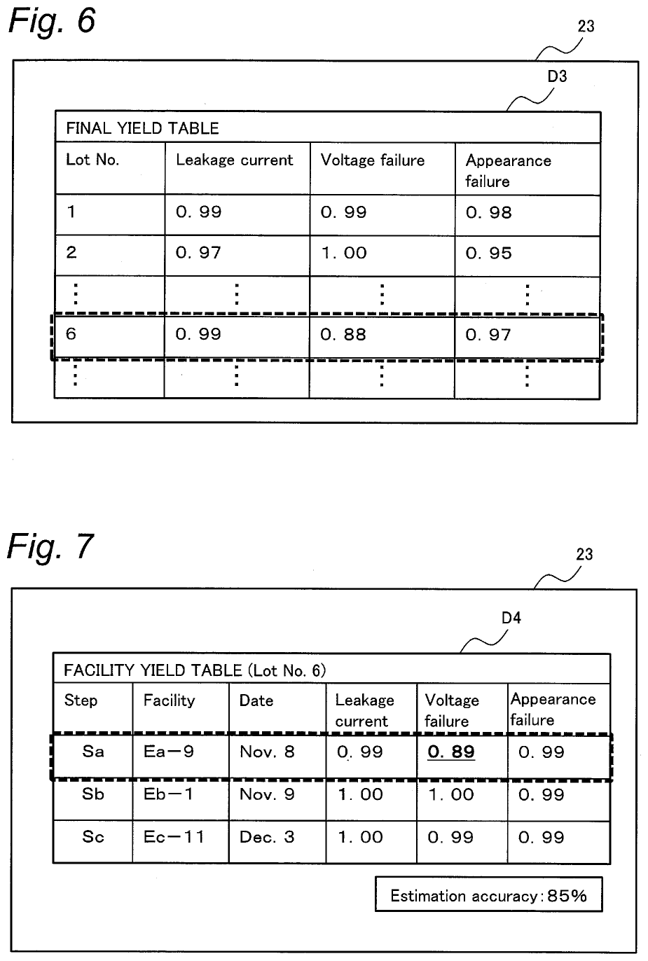

At first, the controller 20 of the quality estimation device 2, serving as the low yield lot detector 31 for example, acquires the lot management data D1 from the memory 21 (S1), and detects a low yield lot (S2). FIG. 6 shows a display example of step S2. In this display example, the display 23 of the quality estimation device 2 is controlled by the controller 20 as the low yield lot detector 31 to display a final yield table D3, for example. The final yield table D3 shows the measured values of various inspection items as the final yield in each lot for each lot number, for example.

In step S2, the low yield lot detector 31 compares the final yield of each lot in the lot management data D1 with a predetermined threshold to determine, as a low yield lot, a lot having final yield equal to or less than the threshold, for example. The threshold indicates a criterion of significantly low final yield. The compared subject with the threshold can be appropriately set to any measured value in various inspection items of the final yield or the total value across the items. In the example in FIG. 6, the lot of lot number “6” is detected and highlighted by the low yield lot detector 31.

In the present embodiment, the controller 20, serving as the bottleneck facility determiner 32, analyzes the facility yield in the route of a specific one lot such as a low yield lot, based on the detection result obtained by the low yield lot detector 31, for example (S3). The bottleneck facility determiner 32 performs the processing in step S3 by acquiring the facility yield estimation information D2 regarding all the facilities E via which the specific lot has passed. The processing of the facility yield analysis in step S3 will be described later. FIG. 7 shows a display example of step S3.

In the example in FIG. 7, the display 23 is controlled by the controller 20 as the bottleneck facility determiner 32 to display a facility yield table D4, for example. For example, the facility yield table D4 includes the facility E in each of steps Sa, Sb, and Sc through which a specific lot has passed, the date when the lot has been processed in each facility E, and an estimated value for each inspection item as the facility yield of each facility E. For example, upon specifying the low yield lot, the user 1 can check the facility yield of each facility E in the route of the low yield lot by the facility yield table D4. Further, in the example in FIG. 7, the bottleneck facility determiner 32 determines that the facility Ea-9 having the lowest facility yield in the facility yield table D4 is bottleneck facility, for example.

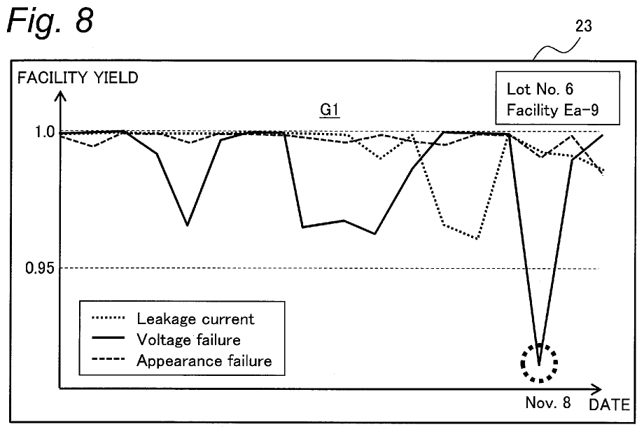

Returning to FIG. 5, the controller 20 according to the present embodiment, serving as the time series analyzer 33, performs a time series analysis of facility yield, based on the determination result obtained by the bottleneck facility determiner 32, for example (S4). The time series analyzer 33 performs the processing in step S4 by acquiring the facility yield estimation information D2 regarding specific facility such as bottleneck facility. FIG. 8 shows a display example of step S4.

In the example in FIG. 8, the controller 20 as the time series analyzer 33 controls the display 23 to display the facility yield graph G1, for example. The facility yield graph G1 shows the time series changes in the facility yield of specific facility, and includes a curve for each inspection item, for example. In the example in FIG. 8, it can be checked from the facility yield graph G1 that a sudden decrease in yield occurred during the processing time of a low yield lot. In this way, by the time series analysis processing in step S4, it is possible to visualize the time when an abnormal lot has been produced for each facility E. The processing in step S4 will be described later. The processing shown in the flowchart of FIG. 5 ends after the execution of step S4, for example.

As described above, the quality estimation device 2 according to the present embodiment can provide a user interface that allows the user to check bottleneck facility corresponding to a low yield lot, and to check a time series change in facility yield by using the facility yield estimation information D2.

In steps S2 and S3 described above, the detection by the low yield lot detector 31 and the determination by the bottleneck facility determiner 32 may be omitted as appropriate. Instead, the quality estimation device 2 may respond to a user operation in which the user 1 designates a specific lot or facility with the operation interface 22 when displaying the tables D3 and D4 on the display 23.

### 2-1. Facility Yield Estimation Method

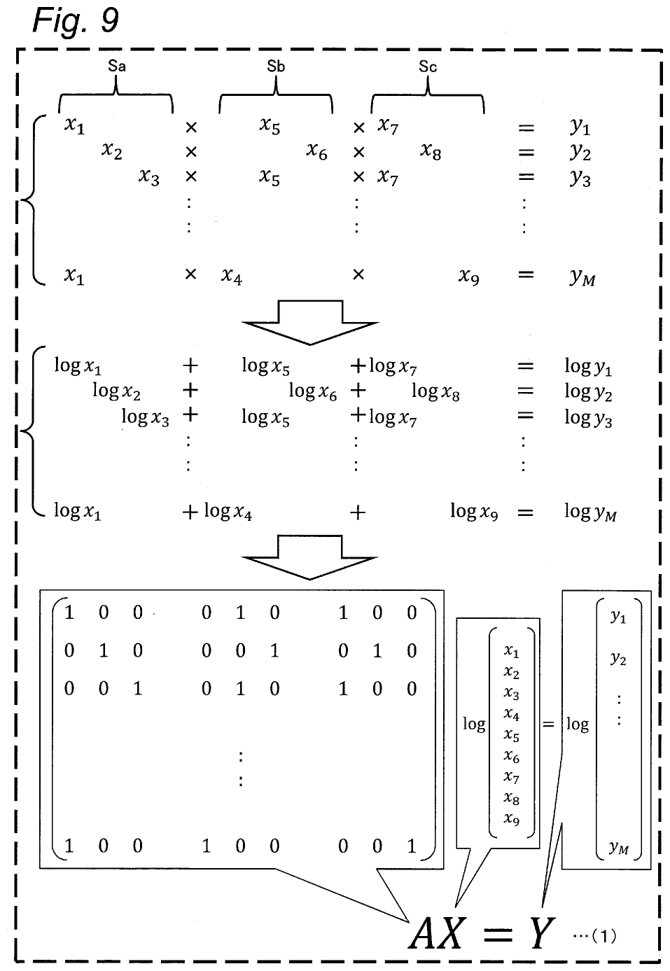

The facility yield estimation method according to the present embodiment will be described below with reference to FIG. 9. FIG. 9 is a view for explaining the formulation of the facility yield estimation method.

FIG. 9 illustrates a final yield yᵢ (i=1, 2, . . . , M) based on M lots and a facility yield xⱼ (j=1, 2, . . . , N) based on N facilities E). The number M of lots and the number N of facilities can be appropriately set within M>N, for example. FIG. 9 shows an exemplary case in which the number N of facilities is 9 in three steps Sa, Sb, and Sc, with three facilities Ea-1 to Ea-3 in step Sa, three facilities Eb-1 to Eb-3 in step Sb, and three facilities Ec-1 to Ec-3 in step Sc, respectively.

This estimation method is based on the insight that the final yield yᵢ of each lot is cumulatively affected by the potential facility yield xⱼ for each facility E due to the lot passing through the respective facilities E in the unique route. The final yield yᵢ of each lot then can be written in the form of the product of a series of the facilities yield xⱼ corresponding to lot route information D10.

As in the example of FIG. 9, the final yield y₁ of the first lot is written in the form of the product of the first facility yield x₁ belonging to step Sa, the fifth facility yield x₅ belonging to step Sb, and the seventh facility yield x₇ belonging to step Sc. The order of lots corresponds to lot numbers within a predetermined range in the lot management data D1, for example. For example, the order of the facilities E is set in order from the facility Ea-1 in step Sa, over all steps Sa to Sc.

Further, as shown in FIG. 9, the product format as described above is converted into a sum formula by taking a logarithm. This makes it possible to formulate the relationship between the final yield yᵢ and the facility yield xⱼ based on the lot route information D10 into a linear simultaneous equation using a logarithm. The individual equations of the simultaneous equations are formulated from, for example, the lot route information D10 for one route. In the present embodiment, as shown in FIG. 9, the matrix format formulation is adopted, and a final yield vector Y, a facility yield vector X, and a route matrix A are used as indicated by Equation (1).

The final yield vector Y is an M-dimensional vector and has a logarithmic value log(yᵢ) of the i-th final yield yᵢ as i-th component (i=1 to M), respectively. The facility yield vector X is an N-dimensional vector having a logarithmic value log(xⱼ) of the j-th facility yield xⱼ as of j-th component (j=1 to N), respectively. The logarithm used for each of the vectors X and Y is not particularly limited, and may be e.g. a common logarithm, a natural logarithm, or a binary logarithm.

The route matrix A is a matrix of M rows and N columns that is set based on the lot route information D10. As shown in FIG. 9, the route matrix A is configured with a pass flag a_{i,j}, which is “1” or “0”, as a matrix element on the i-th row and the j-th column. The pass flag a_{i,j} indicates whether or not the i-th lot has passed through the j-th facility. In the present embodiment, as each lot passes through one facility E for each of steps Sa, Sb, and Sc, the pass flag a_{i,j} on each row of the route matrix A has one “1” in the range of column numbers for each of steps Sa, Sb, and Sc.

Equation (1) can be transformed into a simultaneous linear equation with an excess condition by making the number M of lots larger than the number N of facilities. Therefore, in the present embodiment, Equation (1) is formulated using M pieces of lot route information D10, which are sufficiently large in the lot management data D1, and the facility yield vector X of the numerical solution of Equation (1) is obtained by a least squares method as in the following Expression (10).

subject to: AX=Y,X<0

minimize: |Y−AX|² (10)

The facility yield xⱼ based on such numerical solutions corresponds to the average value of the potential yields among lots passing the corresponding facilities E in the lot management data D1 within the range used for the formulation. The condition X<0 in Expression (10) described above is based on the fact that the facility yield xⱼ is 0 or more and 1 or less. For the solution in the least squares method, the BFGS-B method of the quasi-Newton method can be used, for example.

### 2-2. Facility Yield Analysis Processing

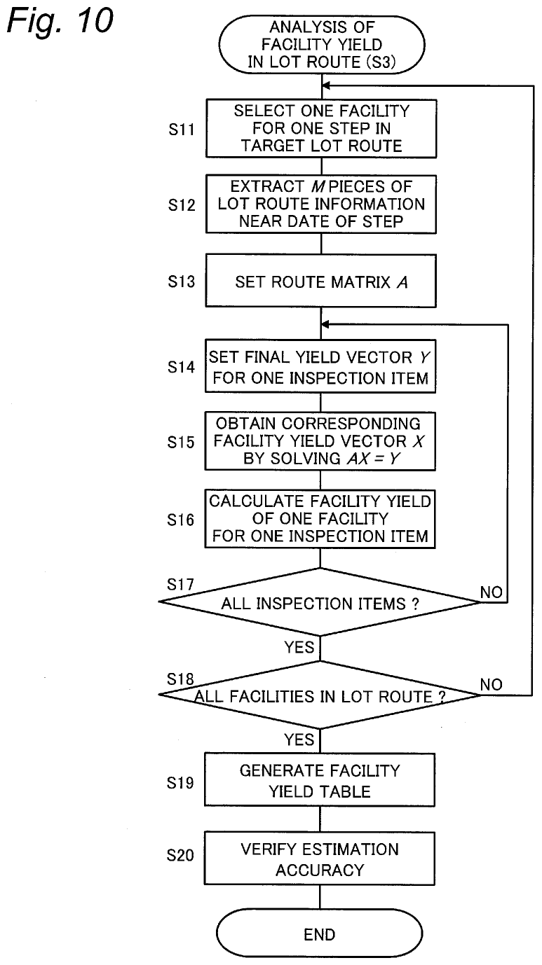

The processing in step S3 in FIG. 5 using the above facility yield estimation method will be described with reference to FIG. 10.

FIG. 10 is a flowchart illustrating facility yield analysis processing (S3 in FIG. 5) in the quality estimation device 2 according to the present embodiment. The processing shown in the flowchart in FIG. 10 is started with one lot such as a low yield lot being specified.

At first, the controller 20, serving as the bottleneck facility determiner 32, selects one facility in the route of the lot as a processing target based on the lot route information D10 regarding the specific lot, for example (S11). The selection in step S11 is sequentially performed for each of steps Sa, Sb, and Sc in the present embodiment. For example, the bottleneck facility determiner 32 acquires the process step and date corresponding to the processing target facility in the lot route information D10 and sets the step and the date as a reference time for processing, in the facility yield estimator 30.

Then, with the date set by the facility yield estimator 30 as the reference time, the controller 20 extracts the plurality of pieces of lot route information D10, in which the date of the set step is within a predetermined period neighbor the reference time, from the lot management data D1, for example (S12). The number M of lots as the number of pieces of lot route information D10 to be extracted may or may not be set in advance. For example, in the lot route information D10 of lot number “6” shown in FIG. 4, date “November 8” of the facility Ea-9 is used as the reference time for step Sa, so that the lot route information D10 with the date in step Sa is collected in step S12 within the range of one week “November 5 to November 11” including the same date.

Then, the controller 20 as the facility yield estimator 30 sets the route matrix A, based on the extracted M pieces of lot route information D10, for example (S13). For example, the controller 20 provides the number of rows for the number of pieces of collected lot route information D10 and the number of columns for all facilities E in all steps Sa to Sc, sets the pass flag a_{i,j} of the column number of the included facilities for each lot route information D10 in each row to “1”, and sets the other pass flags a_{i,j} to “0”.

Next, the controller 20 selects one inspection item from the plurality of inspection items in the extracted lot route information D10, and sets the final yield vector Y so as to represent the final yield of the selected inspection item (S14). For example, the controller 20 computes the logarithm of the measured value of the inspection item selected in each lot route information D10 and sets the calculated logarithmic value to each component of the final yield vector Y.

The controller 20 then performs calculation processing according to Expression (10), based on the set route matrix A and the final yield vector Y, to obtain the numerical solution of Equation (1), thereby calculating the facility yield vector X (S15). At this time, the controller 20 calculates the facility yield of one facility selected in step S11 by calculating the exponent of the corresponding component in the calculated facility yield vector X (S16) and records the yield in the memory 21.

The controller 20 performs the processing in steps S14 to S16 for each inspection item (NO in S17) and calculates the facility yield of each inspection item for the selected facility. At this time, as the route matrix A, the common one set in step S13 is used.

Upon calculating the facility yields of all items with respect to one facility (YES in S17), the controller 20 performs the processing onward step S11 for the other facilities in the route of the specific lot, based on the lot route information D10 for the same lot (NO in S18).

Upon calculating the facility yields of all the facilities E in the route of the specific lot (YES in S18), the controller 20 generates the facility yield table D4 based on the calculated facility yields (S19), to cause the display 23 to display the facility yields as shown in FIG. 7, for example. The facility yield table D4 is an example of facility quality information in the present embodiment. For example, the bottleneck facility determiner 32 determines bottleneck facility based on the calculated facility yield in step S19, and the controller 20 then highlights the information on the corresponding facility in the facility yield table D4.

Further, in the present embodiment, the controller 20 verifies the estimation accuracy by the generated facility yield table D4 (S20). For example, the controller 20 multiplies the calculated facility yields of all the facilities E for each inspection item and determines that the closer the calculated product is to the final yield of a specific lot, the higher the estimation accuracy. The estimation accuracy may be displayed numerically as illustrated in FIG. 7 or may be displayed in the form of a message such as whether or not the accuracy is high.

Upon verifying the estimation accuracy (S20), the controller 20 ends the facility yield analysis processing in the lot route (S3 in FIG. 5).

According to the above processing, the facility yield of each facility in the route of a specific lot is calculated (S16) by sequentially extracting the lot route information D10 of the lot having passed through the facility in the same step as the facility in the same time with reference to the date when the lot has passed through the facility and formulating Equation (1). The facility yield vectors X corresponding to all the facilities E are obtained from the calculation processing (S15) based on Equation (1), but just the corresponding components are used.

Consequently, it is possible to optimize the data that is the basis for facility yield estimation, and thereby to improve the accuracy of facility yield estimation.

### 2-3. Time Series Analysis Processing

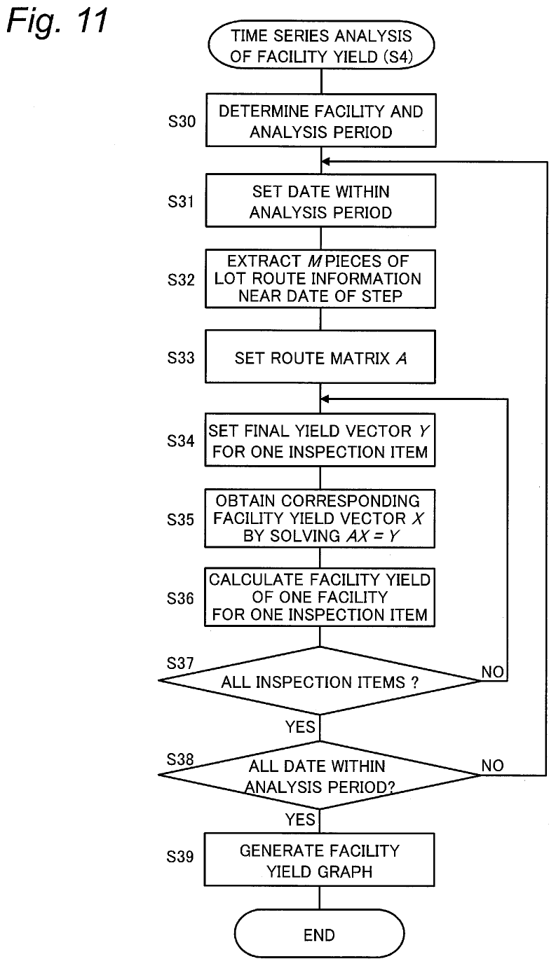

The processing in step S4 in FIG. 5 will be described with reference to FIG. 11.

FIG. 11 is a flowchart illustrating facility yield time series analysis processing (S4 in FIG. 5) in the quality estimation device 2 according to the present embodiment. The processing shown in the flowchart in FIG. 11 is started while one facility such as bottleneck facility is specified.

At first, the controller 20, serving as the time series analyzer 33, acquires information indicating specific facility as a target of the time series analysis, based on the processing results in steps S2 and S3 in FIG. 5, and determines an analysis period that is the range of the period of time series analysis of the facility, for example (S30). For example, when the bottleneck facility in the low yield lot is the analysis target, the controller 20 sets the date of the facility in the lot route information D10 of the low yield lot as a reference, and determines a period such as several months including the date as the analysis period.

In the processing in step S3, the lot route information D10 used for calculating the facility yield is collected for each facility in the route of a specific lot (S11 to S18 in FIG. 10). In the time series analysis processing (S4), the lot route information D10 is collected to calculate the facility yield for each date when the specific facility is used (S31 to S38).

For example, the controller 20 sets in turn a date at the reference time within the determined analysis period (S31), and extracts a plurality of pieces (i.e., M pieces) of lot route information D10 as in step S12 in FIG. 11 with respect to facilities belonging to the common step with the analysis target facility (S32). Then, by formulating Equation (1) based on the extracted lot route information D10, the controller 20 executes calculation processing (S33 to S37) in the same manner as in steps S13 to S17. The controller 20 repeats in turn the processing onward step S31 for each date within the analysis period (NO in S38).

When facility yields for all the dates within the analysis period are calculated (YES in S38), the controller 20 generates the facility yield graph G1 based on the calculation result (S39), and causes the display 23 to display the graph as shown in FIG. 8, for example. The facility yield graph G1 is an example of facility quality information in the present embodiment. For example, after the facility yield graph G1 is displayed, the processing according to this flowchart ends.

According to the above facility yield time series analysis processing, it is possible to visualize the facility yield that may change every moment, by sequentially changing the lot route information D10 for estimating the facility yield for each date within the analysis period (S31 to S38).

### 3. Summary

As described above, the quality estimation device 2 according to the present embodiment generates information on the quality with which a plurality of lots, which are an example of a plurality of unit products, are obtained by using the plurality of facilities E to pass the plurality of steps Sa to Sc, for example. The quality estimation device 2 includes the memory 21 and the controller 20 that is an example of a circuit. The memory 21 stores the lot management data D1 which is an example of quality control data in which the facility through which each lot has passed in each of steps Sa to Sc when the product of each lot is obtained and the quality of the product of the obtained lot are associated with each other. The controller controls calculation processing based on the lot management data D1 stored in the memory 21. The controller 20 extracts, from the lot management data D1, the plurality of pieces of lot route information D10, which are an example of pass records each indicating a combination or a series of facilities through which each lot has passed and the quality of the lot (S12, S32). The controller 20 generates facility quality information indicating a facility yield as an example of the quality with respect to one facility of the plurality of facilities by calculation processing based on the extracted plurality of pass records (S19, S39).

The above quality estimation device 2 generates facility quality information by calculation processing based on the plurality of pieces of lot route information D10 indicating the route constituted by the facilities through which each lot has passed. This can accurately estimate quality per a facility regarding the quality when a plurality of unit products are obtained by using a plurality of facilities.

In the present embodiment, products in lots are obtained by passing the respective facilities Ea-1 to Ea-n, Eb-1 to Eb-n, and Ec-1 to Ec-n corresponding to a plurality of steps Sa to Sc. The controller 20 acquires the time for a lot to pass a specific facility (S11, S31), and extracts the plurality of pieces of lot route information D10 for unit products to pass a group of facilities, which corresponds to the common step with the specific facility, within a predetermined period defined by the acquired time (S12, S32), thereby generating facility quality information regarding the specific facility. This makes it possible to improve the accuracy of quality estimation per a facility based on the appropriate lot route information D10.

In the present embodiment, the controller 20 generates facility quality information by calculation processing according to Expression (10) for obtaining a numerical solution indicating the quality with respect to the facilities respectively in the simultaneous equation (Equation (1)) formulated with the lot route information D10 respectively. This makes it possible to generate highly accurate facility quality information.

In the present embodiment, the facility quality information is the facility yield table D4 indicating the quality of each facility in a lot route, that is, the series of facilities through which a specific unit product in the plurality of unit products has passed, for example. This makes it possible to check the quality of each facility in the lot route.

In the present embodiment, facility quality information is a facility yield graph indicating the quality of specific facility along a time series in a predetermined period such as an analysis period. This makes it possible to check the quality per a facility along a time series.

In the present embodiment, the controller 20 generates facility quality information by extracting M pieces of lot route information D10, which are more than N facilities. This makes it possible to generate highly accurate facility quality information by setting Equation (1) as an excess condition.

In the present embodiment, the unit product is a group of products produced per the lot unit by the plurality of facilities. The facility quality information indicates the yield per a facility. Using such facility quality information makes it possible to accurately estimate the yield in a factory facility.

A quality estimation method according to the present embodiment is a method of generating information on the quality with which a plurality of unit products are obtained by using a plurality of facilities for at least one step. This method includes: by the controller 20 of the computer, extracting a plurality of pass records from quality control data associating the facilities passed for each of the unit products in the step when the unit products are obtained with the quality of the obtained unit products, the plurality of pass records each indicating a series of facilities passed by a unit product in the plurality of unit products and the quality for the unit product. This method includes generating facility quality information indicating the quality with respect to one facility of the plurality of facilities by the calculation processing based on the extracted plurality of pass records.

The present embodiment provides a program for causing the controller of a computer to execute the above quality estimation method. The quality estimation method according to the present embodiment can accurately estimate quality per a facility regarding the quality when a plurality of unit products are obtained by using a plurality of facilities.

### Second Embodiment

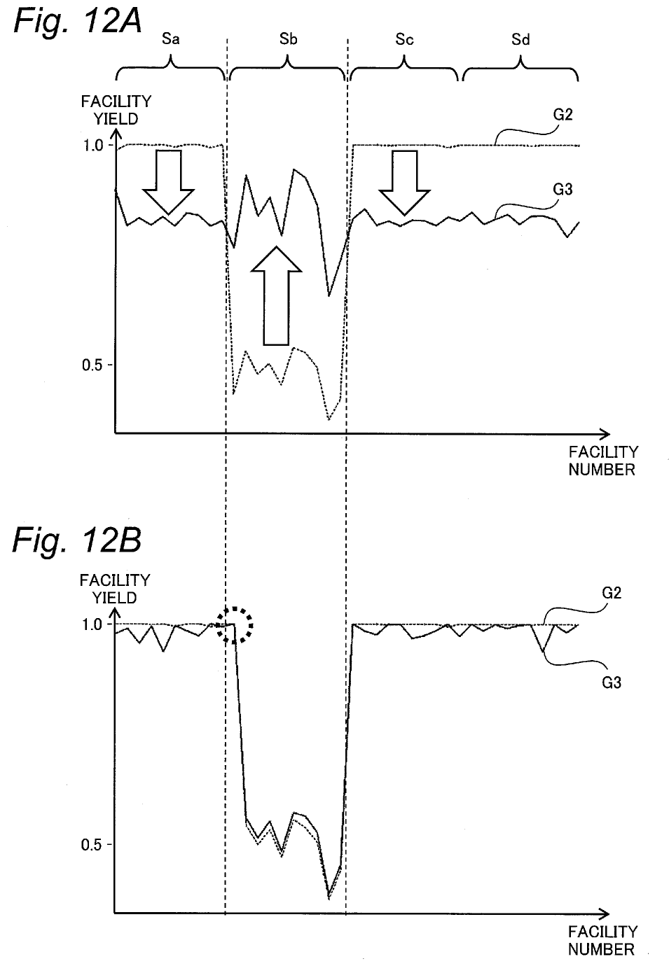

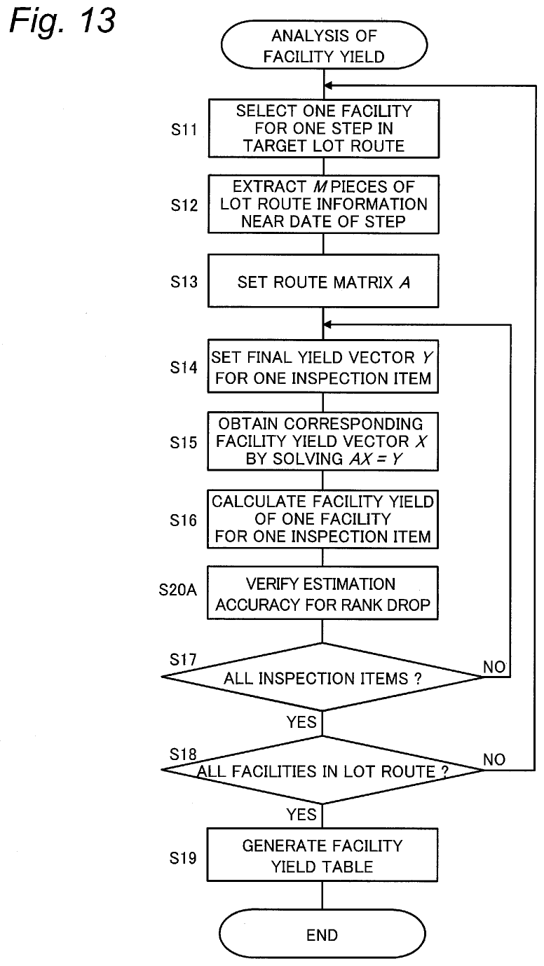

The second embodiment will be described below with reference to FIGS. 12A to 13. The second embodiment will exemplify a theoretical problem found by the diligent research of the inventor of the present application and a practical solution for clearing the problem in the above facility yield estimation method.

The following is a description of a quality estimation device 2 and a quality estimation method according to the present embodiment with the description of the same configuration and operation as those of the quality estimation device 2 according to the first embodiment being omitted as appropriate.

### 1. Finding of Rank Drop

In general, the rank of a matrix has a maximum value of “N” in an M-by-N matrix where M>N. When there are a plurality of lots that pass through the same route, a plurality of rows have the same numerical values in a route matrix A, resulting in causing the rank to drop. However, even when “M” is a sufficiently large number, an example of the route matrix A according to the first embodiment has a constraint for passing one facility in each step, so that the rank of the route matrix A is smaller than the maximum value “N” by (total number of steps minus one). Due to such a rank drop, the calculation processing according to Expression (10) may result in an indefinite solution, for example.

The inventor of the present application has researched the above problem diligently to find that the above problem can be avoided as follows, and thus accurate estimation can be performed under practically normal circumstances such as the presence of sufficient facilities that operate normally in the factory facility.

That is, it is considered that a normal facility has the facility yield “1” within an allowable error range as appropriate by operating without any trouble. The value of the component of the facility yield vector X corresponding to such facility is logarithmic, i.e. “0”. Thus, even if the pass flag a_{i,j} of the column corresponding to the facility in the route matrix A is “1”, it can be regarded as “0”. That is, the constraint regarding a step to which the facility belongs for passing any one of the facilities in the step is substantially removed, which is equivalent to restoring the rank of the route matrix A accordingly. Therefore, the inventor has found that the presence of at least one facility having the facility yield “1” in each process step enables accurate facility yield estimation, by restoring the rank of the route matrix A as a result.

### 1-1. Numerical Simulation

FIGS. 12A and 12B are views for explaining the numerical simulation of the facility yield estimation method. The inventor of the present application performed numerical calculation for a numerical simulation in which the above findings are demonstrated, such that there is an abnormal step with extremely few normal facilities. In this simulation, four steps Sa, Sb, Sc, and Sd including abnormal step Sb were set. The number M of lots was 500, and the total number of facilities was 140. The number of facilities in step Sa was 50, the number of facilities in step Sb was 30, the number of facilities in step Sc was 20, and the number of facilities in step Sd was 40.

FIG. 12A shows the simulation result when steps Sa, Sc, and Sd each include the facility with the facility yield “1”, and there is no facility with the facility yield “1” in abnormal step Sb. FIG. 12B shows the simulation result when there is only one facility with the facility yield “1” in abnormal step Sb. Referring to FIGS. 12A and 12B, the horizontal axis indicates the facility number, and the vertical axis indicates the facility yield.

FIGS. 12A and 12B respectively show a graph G2 of the true value set in the simulation environment and a graph G3 of the estimation result to which this estimation method is applied. In each simulation, assuming that steps Sa, Sc, and Sd other than abnormal step Sb are normal, the true value of each facility yield was set to a value near “1”. The true value of the facility yield in abnormal step Sb was set to about “0.5” on average among the facility.

According to the estimation result graph G3 in FIG. 12A, the facility yield of the estimation result is higher in abnormal step Sb than the true value of the graph G2, while the facility yields in other steps Sa, Sc, and Sd are lower than the true value. As described above, according to the simulation result in FIG. 12A, when there is abnormal step Sb in which there is no facility with the facility yield “1”, it was observed that offset-like errors occur between abnormal step Sb and normal steps Sa, Sc, and Sd in the graph G3 of the estimation result.

In contrast to this, according to the graph G3 of the estimation result in FIG. 12B, the true value graph G2 is reproduced, which indicates that the facility yield in abnormal step Sb is low while the facility yields in other steps Sa, Sc, and Sd are high. As described above, the simulation result in FIG. 12B has revealed that only the presence of one facility with the facility yield of “1” in abnormal step Sb similar to that in FIG. 12A can significantly reduce the error in the yield estimation result obtained by this estimation method as compared with the case in FIG. 12A.

### 2. Operation

The second embodiment provides the quality estimation device 2 that verifies whether or not estimation is performed with high accuracy as shown in FIG. 12B. The operation of the quality estimation device 2 according to the present embodiment will be described with reference to FIG. 13.

FIG. 13 is a flowchart illustrating facility yield analysis processing in the quality estimation device according to the second embodiment. For example, the quality estimation device 2 according to the present embodiment verifies the estimation accuracy regarding the influence of the rank drop described above, instead of the processing in step S20 in the facility yield analysis processing (FIG. 10) similar to the first embodiment (S20A).

For example, in step S20A, the controller 20 of the quality estimation device 2 determines whether or not a component having the value “0” is present for each step in a facility yield vector X, based on the numerical solution obtained in step S15. The component of the value “0” in the facility yield vector X indicates that the facility yield of the corresponding facility is. “1”. For example, the controller 20 verifies the estimation accuracy in multiple stages according to the number of preset steps so that the estimation accuracy is determined higher as the number of steps determined to have a component of the value “0” increases.

According to the above processing, in a factory facility or the like, it is possible to confirm that highly accurate estimation is performed as shown in FIG. 12B. Even in the case as shown in FIG. 12A, it is possible to check the situation of deterioration in accuracy. Further, according to the processing in step S20A, it is possible to verify the estimation accuracy for each facility yield, e.g. every time the facility yield in one inspection item of one facility (S16).

In the above description, an example is explained where the verification of the estimation accuracy regarding the rank drop is performed in the analysis processing of the facility yield in the lot route. However, the verification of the estimation accuracy may be performed in the processing of time series analysis. For example, the same processing as in step S20A may be performed with respect to the facility yield calculated in step S36 in FIG. 11.

In the present embodiment, products in lots may include a product for which one or more steps are not performed. That is, the above lots may include a lot that does not pass facilities in a corresponding step. Such a lot routes can be managed as lot route information D10 skipping the above steps in lot management data D1. When such lot route information D10 is used for a route matrix A, the restriction on the skipped step is removed, and hence the rank of the route matrix A is increased by that amount.

Accordingly, in step S20A described above, the controller 20 may further determine whether or not there is a skipped step in the lot route information D10 used for the route matrix A. The skipped step can be regarded in the same manner as a step having the facility with the facility yield “1”. Therefore, the controller 20 determines that the estimation accuracy is higher as fewer of the number of steps in which it is determined that no component with the value “0” is present among the steps through which all the pieces of lot route information D10 used for the route matrix A passes (S20A). This makes it possible to accurately verify a decrease in estimation accuracy due to a rank drop of the route matrix A.

### 3. Summary

As described above, according to the second embodiment, the controller 20 determines the estimation accuracy of the facility quality information to be higher as the number of specific step is fewer, the specific step corresponding to a group of facilities passed by every lot in the lot route information D10 used for the route matrix A wherein the facility yield vector X of the numerical solution does not have a predetermined value such as “0” as the quality with respect to the group of facilities (S20A). This makes it possible to accurately verify the estimation accuracy of facility quality information.

### Other Embodiments

As described above, the first and second embodiments have been described as examples of the technique disclosed in the present application. However, the technique in the present disclosure is not limited to this and can be applied to embodiments in which changes, substitutions, additions, omissions, and the like are made as appropriate. It is also possible to combine the respective constituent elements described in each of the above embodiments into a new embodiment. Therefore, other embodiments will be exemplified below.

The first and second embodiments have exemplified the electronic components as an example of products in lots. In the present embodiment, products in lots are not particularly limited, and may be various parts such as semiconductor parts or mechanical parts, or finished products such as electronic devices, for example. The present disclosure can be applied to a step in which one lot is one part with the final yield being OK or not, that is, “1” or “0”. The idea of the present disclosure can also be applied to a case in which some lots skip a specific step.

The above embodiments have exemplified the case in which the quality estimation device 2 is applied to the factory facility. In the present embodiment, the quality estimation device 2 can be applied to various fields such as logistics and data communication. Further, the unit products are not limited to products in lots and may be various tangible objects handled by various units or may be data having a unit such as a packet.

For example, as process steps in logistics, there is a series of steps such as moving from receipt to a delivery source base, further traveling a long distance, and delivering to a delivery destination when the delivery destination base is reached. The facilities in this case include a pickup/delivery vehicle, a base, and a long-distance transportation means. For example, the long-distance transportation means is bullet train, airmail, truck, or the like. The quality such as yield in this case can be set to the customer satisfaction rate (=1.0 minus complaint rate) in logistics, for example.

In data communication, there may be only one process step, for example. It is possible to estimate the quality when passing a plurality of facilities in one step. The facilities include a base station and a router, for example. The quality such as yield in this case can be set to the packet pass rate, for example. As described above, even when a lot passes through the same step a plurality of times, appropriately setting the route matrix A makes it possible to obtain a numerical solution in the same manner as described above, and thereby possible to estimate the quality per the facility.

In the above embodiments, calculation processing (S13 to S16, S33 to S36) for calculating a facility yield has been described to perform in various facility yield analysis processing. However, such calculation processing may be performed in advance. For example, the facility yield estimation information D2 obtained in advance using various pieces of lot route information D10 may be appropriately stored in the memory 21 or an external storage device in the form of a database. At the analysis processing, the controller 20 can acquire a facility yield corresponding to the lot route information D10 corresponding to each condition from the database, to generate facility quality information.

As described above, the embodiments have been described as examples of the technique disclosed in the present disclosure. For this purpose, the accompanying drawings and detailed description are provided.

Therefore, components in the accompanying drawings and the detailed description may include not only components essential for solving problems, but also components that are provided to illustrate the above technique and are not essential for solving the problems. Accordingly, such inessential components should not be readily construed as being essential based on the fact that such inessential components are shown in the accompanying drawings or mentioned in the detailed description.

Furthermore, since the embodiments described above are intended to illustrate the technique in the present disclosure, various changes, substitutions, additions, omissions, and the like can be made within the scope of the claims and the scope of equivalents thereof.

The present disclosure can be applied to various fields such as factory facilities, logistics, and data communication.

1. A quality estimation device for generating information on quality with which a plurality of unit products are obtained by using a plurality of facilities to pass at least one step, the quality estimation device comprising:
a memory that stores quality control data associating the facilities passed for each of the unit products in the step when the unit products are obtained, with the quality for the obtained unit products; and
a circuit that controls calculation processing based on the quality control data stored in the memory,
wherein the circuit
extracts a plurality of pass records from the quality control data, the plurality of pass records each indicating a series of facilities passed by a unit product in the plurality of unit products and the quality for the unit product, and
generates facility quality information indicating the quality with respect to a facility in the plurality of facilities by the calculation processing, based on the extracted pass records.

2. The quality estimation device according to claim 1, wherein
the unit product is obtained by passing corresponding facilities to a plurality of steps respectively, and
the circuit
acquires a time for the unit product to pass a specific facility, and
extracts the plurality of pass records for a part or whole of the plurality of unit products to pass a group of facilities within a predetermined period defined by the acquired time, to generate the facility quality information with respect to the specific facility, the group of facilities corresponding to a common step with the specific facility.

3. The quality estimation device according to claim 1, wherein the circuit generates the facility quality information by the calculation processing to obtain a numerical solution indicating the quality with respect to the plurality of facilities respectively in a simultaneous equation formulated with each of the plurality of pass records.

4. The quality estimation device according to claim 3, wherein the circuit determines estimation accuracy of the facility quality information to be higher as the number of specific step is fewer, the specific step corresponding to a group of facilities passed by every unit product in the plurality of pass records wherein the numerical solution does not have a predetermined value as the quality with respect to the group of facilities.

5. The quality estimation device according to claim 1, wherein the facility quality information indicates the quality with respect to each facility in the series of facilities passed by a specific unit product in the plurality of unit products.

6. The quality estimation device according to claim 1, wherein the facility quality information indicates the quality with respect to a specific facility along a time series in a predetermined period.

7. The quality estimation device according to claim 1, wherein the circuit extracts the plurality of pass records more than the plurality of facilities, to generate the facility quality information.

8. The quality estimation device according to claim 1, wherein the unit product is a group of products produced per a lot unit by the plurality of facilities, and the facility quality information indicates a yield per the facility.

9. A quality estimation method for generating information on quality with which a plurality of unit products are obtained by using a plurality of facilities to pass at least one step, the quality estimation method, performed by a circuit of a computer, comprising:
extracting a plurality of pass records from quality control data, the quality control data associating the facilities passed for each of the unit products in the step with the quality for the obtained unit products, the plurality of pass records each indicating a series of facilities passed by a unit product in the plurality of unit products and the quality for the unit product; and
generating facility quality information indicating the quality with respect to a facility in the plurality of facilities by the calculation processing based on the extracted pass records.

10. A non-transitory computer-readable recording medium storing a program for causing the circuit of the computer to execute the quality estimation method according to claim 9.
